(19) United States
(12) Patent Application Publication
(10) Pub. No.: US 2016/0121507 A1
(43) Pub. Date: May 5, 2016

(54) ROTARY CUTTING DIE FOR CUTTING CORRUGATED BOARD AND HAVING A PERFORATING RULE THAT RESISTS HANGING-UP IN THE CORRUGATED BOARD

(71) Applicant: CONTAINER GRAPHICS CORPORATION, Cary, NC (US)

(72) Inventor: James M. Smithwick, Holly Springs, NC (US)

(73) Assignee: CONTAINER GRAPHICS CORPORATION, Cary, NC (US)

(21) Appl. No.: 14/527,083

(22) Filed: Oct. 29, 2014

(51) Int. Cl. B26F 1/20; B26D 1/40; B26F 1/38

(52) U.S. Cl. CPC B26F 1/20; B26F 1/384; B26D 1/405

(57) ABSTRACT

A rotary cutting die apparatus for cutting and perforating corrugated board comprises a die board having one or more perforating rules. The perforating rule includes a series of spaced apart perforating segments disposed along one edge of the rule. Each perforating segment includes opposed angled shoulders that reduce or minimize the tendency of the corrugated board from becoming hung-up or held on the perforating segments when the perforating segments penetrate the corrugated board to form perforations therein.

### FIELD OF THE INVENTION

The present invention relates to corrugated board die cutting devices and processes, and more particularly to a corrugated board cutting die for cutting, scoring and perforating corrugated board.

### BACKGROUND OF THE INVENTION

Rotary cutting dies for operating on corrugated board typically include a die board that includes rules or blades that perform cutting, scoring and perforating functions on the corrugated board. Perforating rules secured to the die board are utilized to form perforation in the corrugated board. These perforating rules form fold lines that enable portions of the corrugated board to be folded along these lines of perforations. One of the problems typically faced with die boards having perforating rules is that the corrugated board tends to hang up the perforating rule. For example, in the case of a rotary cutting die, a corrugated board is directed through a nip defined between the die board and an anvil. As the perforating rule enters the nip, it will engage and penetrate the corrugated board and form a perforation line therein. Sometimes the perforating rule will hang up in the corrugated board. This results in the corrugated board staying attached to and wrapping around the rotating die cutting device, causing press jams. Press jams create wasted corrugated board, production stoppage to clear the press jam and commonly a reduction in press speed when the press run is restarted.

### SUMMARY OF THE INVENTION

The present invention comprises a die board for cutting corrugated board that includes a perforating rule designed to penetrate the corrugated board in such a fashion that the corrugated board does not hang up on the perforating rule. This is achieved by a perforating rule having a series of perforating segments (serrated or non-serrated) where there is provided an inclined or angled shoulder on opposite sides of each perforating segment. The angled shoulders provided on opposite sides of each perforating segment form a leading and trailing edge that because of its orientation relative to the perforating segments results in the perforating segments entering and exiting the corrugated board without the corrugated board becoming hung up on the perforating segments.

In one particular embodiment, the inclined or angled shoulders disposed on opposite sides of each perforating segment are provided with an outer beveled cutting edge that penetrates the corrugated board as the corrugated board passes through the nip formed between the die board and an anvil. Beveled edges of the inclined shoulders tend to form a leading and trailing edge for each perforating segment that resists hanging up in the corrugate board. That is, the beveled cutting edges of the inclined shoulders tend to enter and exit the corrugated board in a smooth and orderly manner without the corrugated board tending to adhere or bind to the perforating rule.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of a rotary cutting die apparatus including a cylinder, anvil and a corrugated board cutting die.

FIG. 2A is a side elevational view of a perforating rule employed in the rotary cutting die apparatus of FIG. 1.

FIG. 2B is an alternative design of the perforating rule.

FIG. 2C is another alternative design of the perforating rule showing a combination perforating and scoring rule.

FIG. 3A is a fragmentary view showing a section of another alternative design for the perforating rule.

FIG. 3B is a fragmentary view of the perforating rules shown in FIG. 3 and illustrating the angle of a shoulder that is formed along one side of a perforating segment.

FIG. 4A is a fragmentary sectional view showing a piece of corrugated board being directed through the nip of the rotary cutting die apparatus prior to the corrugated board being engaged by the perforating rule.

FIG. 4B is a view similar to FIG. 4A but showing the corrugated board actually passing through the nip and being engaged by the perforating rule.

### DESCRIPTION OF EXEMPLARY EMBODIMENT

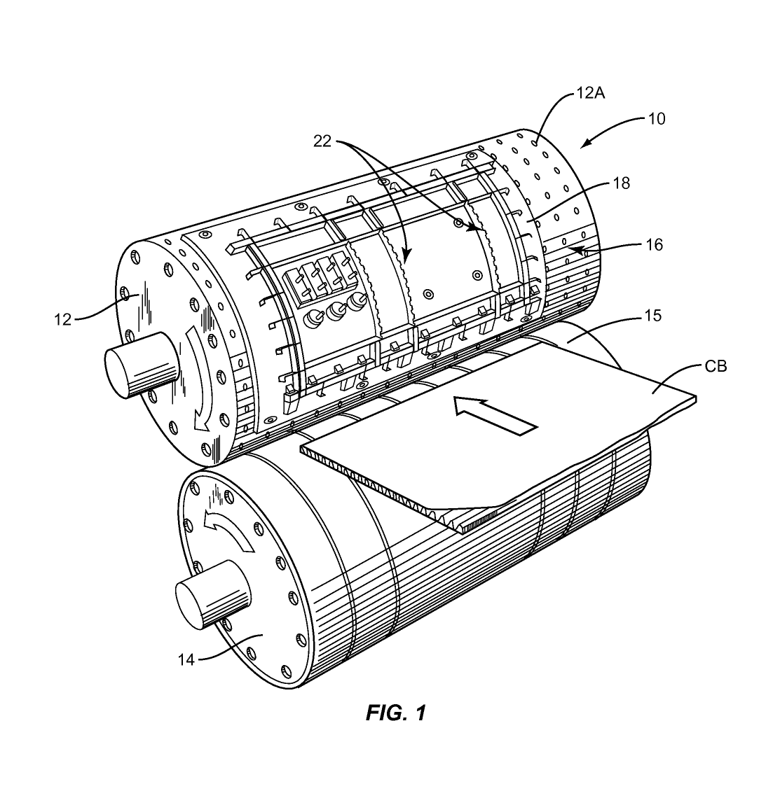

With further reference to the drawings, particularly FIG. 1, there is shown therein a rotary die cutting apparatus indicated generally by the numeral 10. Rotary cutting die apparatus 10 includes a cylinder 12 and an anvil 14. Cylinder 12 and anvil 14 are conventional and form a part of a conventional rotary die cutting apparatus. Cylinder 12 is adapted to receive a corrugated board cutting die indicated generally by the numeral 16. Cutting die 16 is bolted or secured to the cylinder 12. In a die scoring and cutting operation, corrugated board CB, shown in FIG. 1, is fed through the nip 15 that exists between the cylinder 12 and anvil 14. As the cutting die 16 rotates with the cylinder 12, various components of the cutting die, such as scoring rules, cutting rules, product ejectors, scrap ejectors, etc. engage the corrugated board CB and perform various operations on the corrugated board.

Cutting die 16 includes a die board 18. In this example, die board 18 is of a circular or arcuate configuration. Cylinder 12 includes threaded bores 12A. Further, die board 18 includes fastener openings that permit bolts or other fastening means to extend through the die board into the threaded bores 12A. This secures the die board 18 to the cylinder 12. As noted above, die board 18 includes numerous die elements or parts that engage and operate on the corrugated board CB. In the embodiment illustrated in FIG. 1, the die board 18 is a circular die board and is especially suited for use in the rotary die cutting apparatus 10.

As noted above, a typical die board 18 is provided with one or more scoring rules, one or more cutting rules or blades, one or more perforating rules, scrap ejectors, product ejectors and numerous other types and forms of working elements. Details of the die cutting apparatus are not dealt with herein because such is not per se material to the present invention and the basic structure and operation of conventional corrugated board die cutting machines are well known and appreciated by those skilled in the art.

The particular problem addressed by the present invention relates to the perforating rule and the tendency of the corrugated board to become hung-up on the perforating rule even for the slightest amount of time as the corrugated board and the perforating rule pass through the nip 15 defined between the cylinder 12 and anvil 14. The present application provides a corrugated board cutting die that includes one or more perforating rules where the perforating rule is designed to reduce or minimize the tendency of the corrugated board to be held by the perforating rule during a perforating operation.

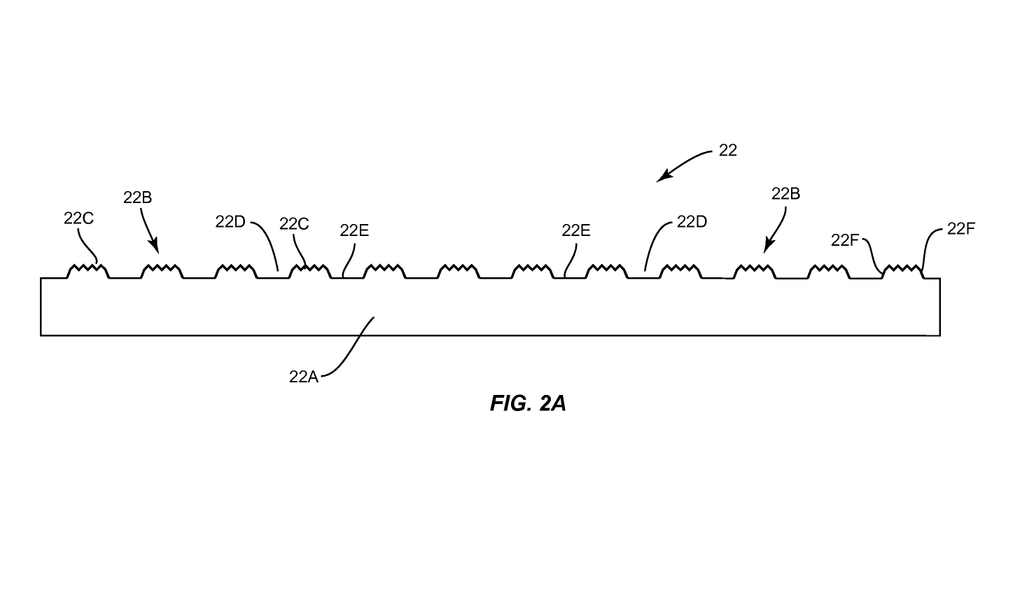

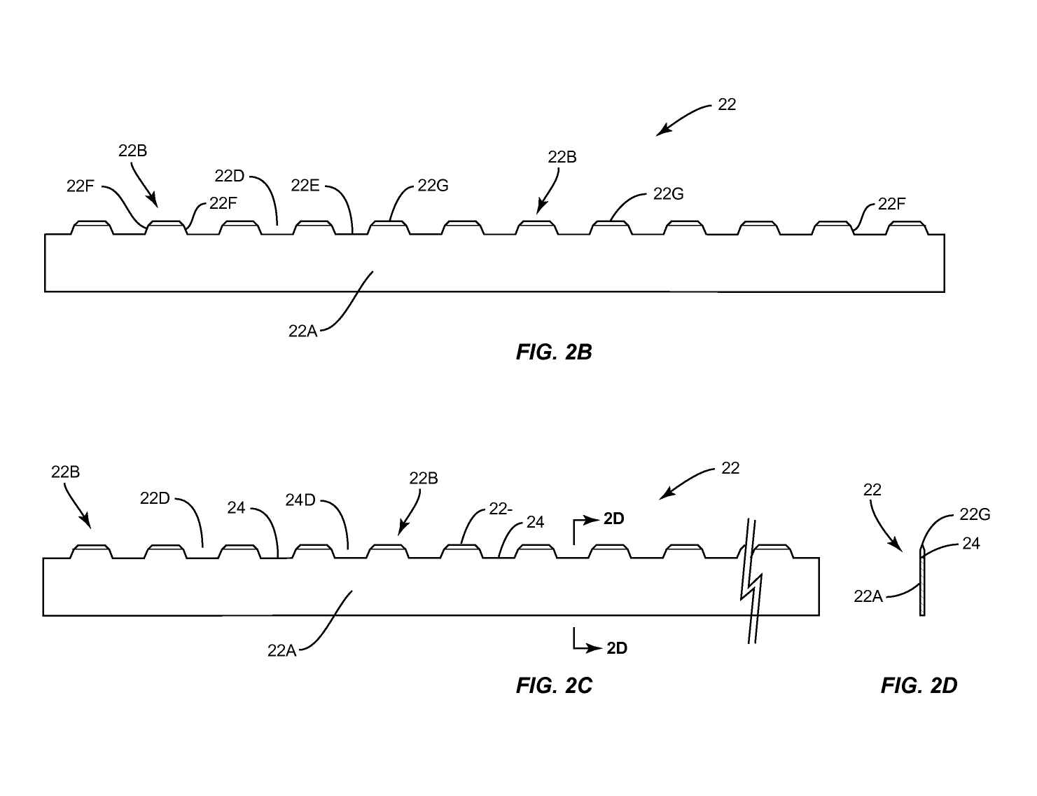

As seen in FIG. 1, the die board 18 is provided with a number of perforating rules 22. Perforating rules can extend transversely across the die board 18 or the perforating rules can be arcuate or curve-shaped and extend in the direction of rotation of the die board. If the perforating rule 22 extends transversely across the die board 18, it will generally comprise a straight perforating rule as shown in FIG. 2A. If the perforating rule extends across the die board 18 in the direction of the die board's rotation, then the perforating rule 22 will be curved or arcuate-shaped in order to fit the die board 18.

Turning to FIG. 2A, one embodiment for the perforating rule 22 is shown therein. As seen in FIG. 2A, the perforating rule 22 includes a main body 22A. About an outer exposed edge of the perforating rule 22 there is provided a series of spaced apart perforating segments indicated generally by the numeral 22B. Each perforating segment 22B in this embodiment includes a series of teeth 22C which may be beveled. In the case of the embodiment shown herein, each perforating segment 22B includes four teeth but it is appreciated that the number of teeth can vary. An open space 22D is provided between consecutive perforating segments 22B. In addition, the main body 22A of the perforating rule 22 includes a non-perforating segment 22E that extends between consecutive perforating segments 22B. As seen in FIG. 2A, the non-perforating segments 22E are stepped down relative to the outer points of the teeth 22C. In the embodiment shown in FIG. 2A, the non-perforating segments 22E are spaced relative to the perforating segments such that preferably the non-perforating segments do not touch or engage the corrugated board CB during a perforating operation. As described below with respect to FIG. 2C, the non-perforating segments 22E can form scoring segments. In this case and as explained below, the non-perforating segments are designed so as to have a generally curved edge that will engage the corrugated board CB and score the corrugated board between the perforations formed by the perforating segments.

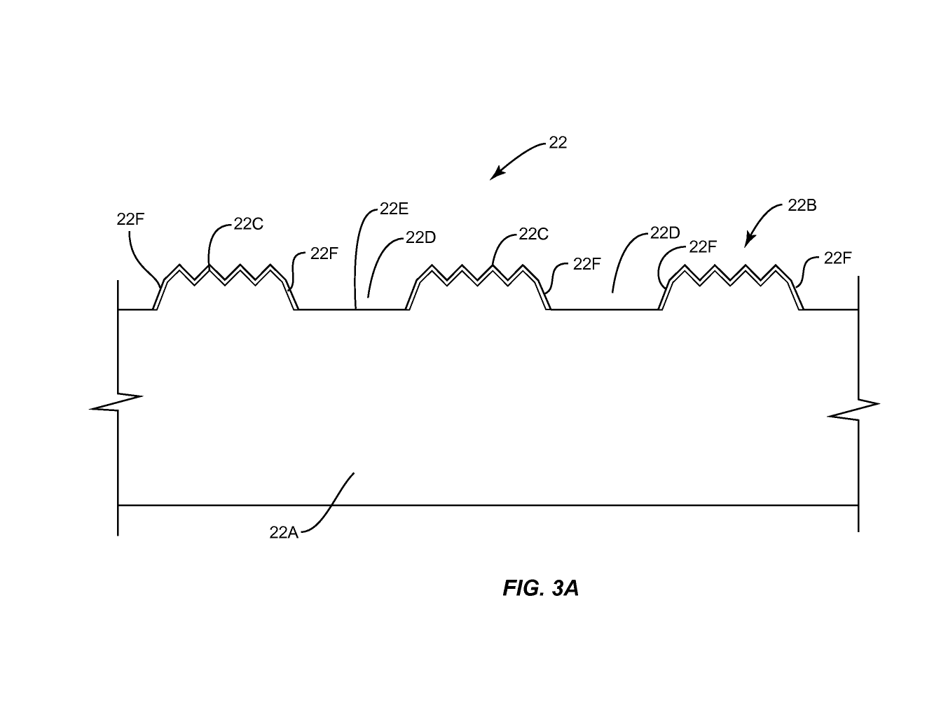

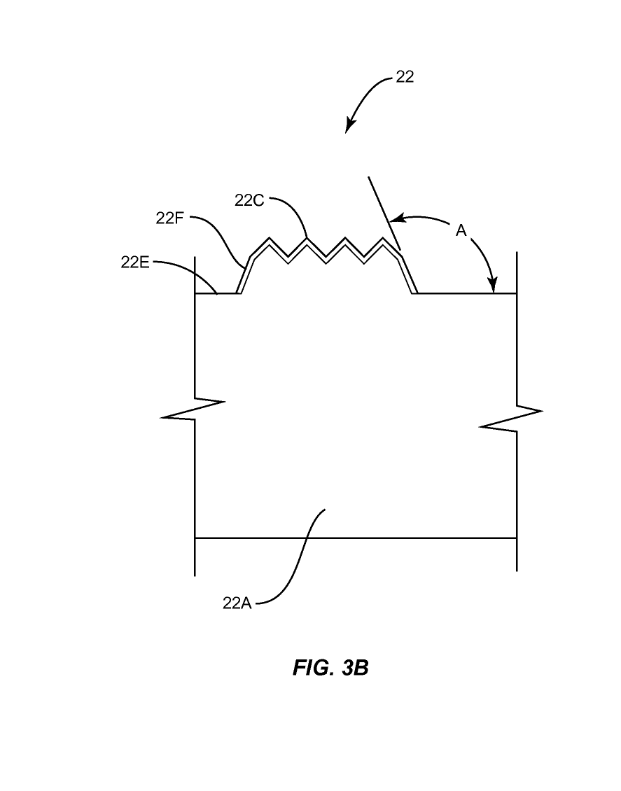

Each perforating segment 22B includes a pair of opposed angled shoulders 22F. Note that the angled shoulders extend upwardly from the main body 22A of the rule and can effectively form a leading or trailing edge of each perforating segment 22B. Each shoulder 22F is angled, in the case of the FIG. 2 embodiment, at an angle (shown as angle A) greater than 90° with respect to the adjacent non-perforating segment 22E. See FIG. 3A. It is this angular orientation of the shoulders 22F that contribute to solving the problem of the corrugated board hanging up or being held by the perforating segments as the corrugated board CB travels through the nip 15. By angling the shoulders 22F, a smoother and orderly entry into and exit from the corrugated board CB is assured. This reduces or minimizes the tendency of the corrugated board CB to be held on the perforating segments 22B.

In the FIG. 2A embodiment, the perforating segments 22B are serrated, that is they include teeth. It should be pointed out that the perforating segments 22B do not have to be serrated. That is, as viewed in FIG. 2B, the teeth of the perforating segments (FIG. 2A) are replaced by a beveled perforating edge 22G. This constitutes a non-serrated perforating segment 22B. The function of the perforating rule 22 with the non-serrated perforating segment 22B is the same. That is, the non-serrated perforating segments 22B of FIG. 2B forms spaced apart perforations in the corrugated board CB that enable the corrugated board CB to be folded along the perforations formed in the corrugated board.

FIG. 2C shows another alternative design for the perforating rule 22. In this case, the design shown in FIG. 2C is the same as that shown in FIG. 2A or FIG. 2B except that there are formed scoring segments 24 between selected perforating segments 22B. That is, the scoring segments 24 formed in the rule 22 in FIG. 2C includes a curved or arcuate-shaped upper edge that scores the corrugated board CB between the perforations formed by the perforating segments 22B. As discussed above, the non-perforating segments 22E, shown in FIGS. 2A and 2B, are not intended to engage the corrugated board. However, the scoring segments 24 that form a part of the design shown in FIG. 2C is, in fact, designed to engage and score the corrugated board. This means that the perforating rule 22 shown in FIG. 2C is a combination rule that both perforates the corrugated board and scores the corrugated board with the perforations and scoring all being aligned. That is, the rule 22 shown in FIG. 2C produces a line in the corrugated board that includes spaced apart perforations and spaced apart scoring. In the embodiment illustrated in FIG. 2C, the scoring segments 24 are disposed between consecutive perforating segments 22B. However, it should be pointed out that there does not have to be a one-to-one relationship between the scoring and the perforations as the scoring segments 24 can be placed on the rule shown in FIG. 2C in various positions with respect to the perforating segments 22B.

FIG. 3A shows another alternative design for the perforating rule 22. In this alternative design, the angled shoulders 22F are beveled to form a cutting edge. Note in FIG. 3A where each of the angled shoulders 22F includes a bevel that begins at the non-perforating segment 22E or at a point close thereto and extends upwardly along the edge of the angled shoulder 22F to form a cutting edge. The bevel and cutting edge appears on both sides of the angled shoulders 22F. Thus, in this embodiment, the beveled and angled shoulders 22F of each perforating segment 22B tend to cut into and move through the corrugated board CB with relative ease.

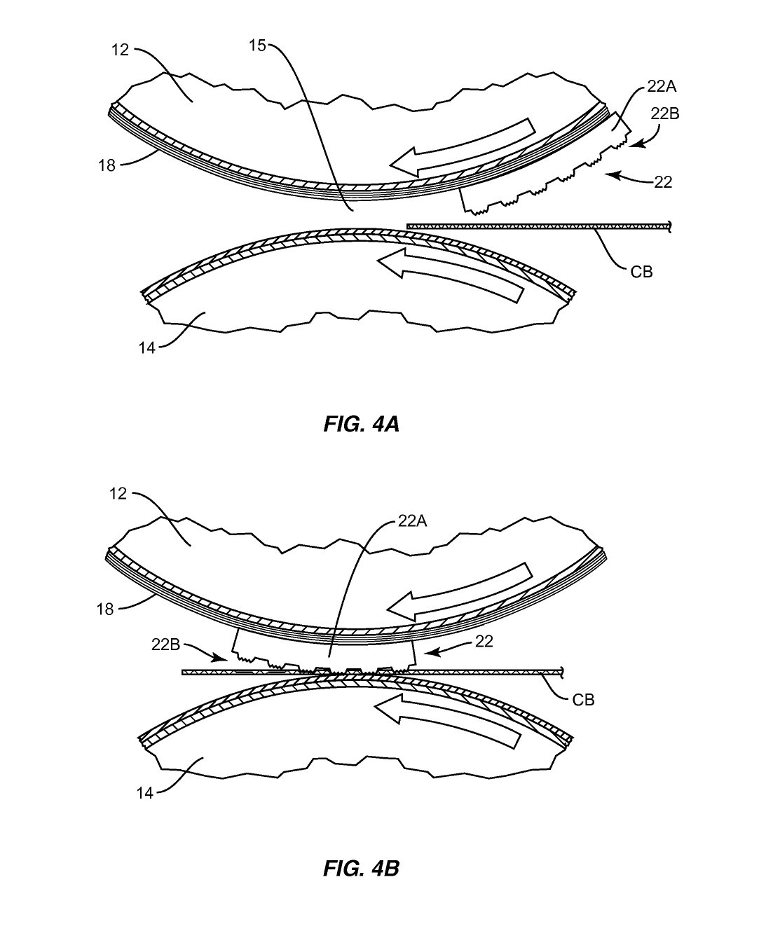

FIGS. 4A and 4B show fragmentary side sectional views of the rotary die cutting apparatus of the present invention and illustrate a sheet of corrugated board CB being directed through the nip 15 between the die board 18 and anvil 14. Note in FIG. 4A where the die board 18 is rotating clockwise while the anvil 14 is rotating counterclockwise. Corrugated board CB is fed into the nip 15 and, as illustrated in FIG. 4B, the perforating rule 22 rotates into engagement with the corrugated board as the corrugated board moves through the nip. Note that the teeth 22C of each perforating segment 22B engage and penetrate through the upper surface of the corrugated board to form a line of spaced apart perforations along the corrugated board. Because of the angled shoulders 22F, each perforating segment 22B enters and exits the corrugated board CB in such a manner that, due to the angular orientation of the shoulder 22F, the shoulder does not tend to become hung-up or held in the corrugated board or the corrugated board does not tend to adhere to the perforating rule 22. Because the corrugated board CB is not held by the perforating rule, this enables the corrugated board to be precisely cut.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A rotary cutting die for cutting and perforating corrugated board, comprising:
a curved die board configured to mount on a cylinder having at least one cutting blade and one perforating blade mounted thereon, and wherein the die board is configured to cut and perforate corrugated board passing through a nip between the die board and a rotary anvil;
the perforating rule including a main body having an exposed perforating edge that comprises a series of spaced apart perforating tooth segments with each tooth segment including a series of teeth;
wherein the tooth segments are separated by open spaces formed in the perforating rule; and
an inclined shoulder extending on at least one side of each tooth segment that penetrates the corrugated board as the corrugated board passes through the nip.

2. The rotary cutting die of claim 1 wherein the one or more open spaces between the tooth segments is bound by two inclined shoulders and a non-perforating segment of the main body of the perforating rule.

3. The rotary cutting die of claim 1 further including a beveled cutting edge formed on at least some of the inclined shoulders.

4. The rotary cutting die of claim 2 wherein each shoulder extends at an angle greater than 90° with respect to an adjacent non-perforating segment of the perforating rule.

5. The rotary cutting die of claim 1 wherein the scoring rule includes a series of scoring segments interposed between at least some of the perforating tooth segments.

6. The rotary cutting die of claim 1 wherein the teeth of the tooth segments and the angled shoulders are beveled to form a cutting edge that extends along the angled shoulders and the teeth that extend between the shoulders.

7. A rotary cutting die for cutting and perforating corrugated board, comprising:
a curved die board configured to mount on a cylinder having at least one cutting blade and one perforating blade mounted thereon, and wherein the die board is configured to cut and perforate corrugated board passing through a nip between the die board and a rotary anvil;
the perforating rule including a main body having an exposed perforating edge that comprises a series of spaced apart perforating segments projecting from the main body;
wherein the perforating segments are separated by open spaces formed in the perforating rule;
an inclined shoulder extending from at least one side of each perforating segment towards the main body of the perforating rule;
the perforating rule including a series of non-perforating segments that extend between the perforating segments; and
wherein each inclined shoulder extends at an angle greater than 90° to an adjacent non-perforating segment of the main body of the perforating rule.

8. The rotary cutting die of claim 7 wherein each open space between the perforating segments is bound by two inclined shoulders and one non-perforating segment.

9. The rotary cutting die of claim 7 wherein each inclined shoulder includes a beveled cutting edge.

10. The rotary cutting die of claim 7 wherein the perforating rule is a combination perforating and scoring rule and includes a plurality of scoring segments disposed between selected perforating segments for scoring and perforating portions of the corrugated board as the corrugated board passes through the nip such that a series of spaced apart perforated segments is formed in the corrugated board and a series of scored segments is formed in the corrugated board between some of the perforated segments.

11. The rotary cutting die of claim 7 wherein each perforating segments include a series of teeth.

12. The rotary cutting die of claim 7 wherein each perforating segment includes a beveled cutting edge.
